(19) United States
(12) Patent Application Publication
(10) Pub. No.: US 2016/0255221 A1
(43) Pub. Date: Sep. 1, 2016

(54) APPARATUS, INFORMATION PROCESSING SYSTEM, INFORMATION PROCESSING METHOD, AND COMPUTER PROGRAM PRODUCT

(71) Applicant: Satoshi TAKAHASHI, Kanagawa (JP)

(72) Inventor: Satoshi TAKAHASHI, Kanagawa (JP)

(21) Appl. No.: 15/048,392

(22) Filed: Feb. 19, 2016

(30) Foreign Application Priority Data
Feb. 26, 2015 (JP) 2015-036829

(51) Int. Cl. H04N 1/00

(52) U.S. Cl. CPC H04N 1/00477; H04N 1/00411; H04N 1/00204; H04N 2201/0094

(57) ABSTRACT

An apparatus includes a display unit in which data is displayed; a first reception unit configured to receive input of the data to be displayed in the display unit and a display condition for displaying the data; a determination unit configured to determine whether the display condition is satisfied in accordance with a change of status of the apparatus; and a display control unit configured to display the data in the display unit in response to an event in which the determination unit determines that the display condition is satisfied.

### BACKGROUND OF THE INVENTION

1. Field of the Invention

The disclosures herein generally relate to an apparatus, an information processing system, an information processing method, and a computer program product for being executed on a computer.

2. Description of the Related Art

In an apparatus including an operation panel such as a multifunction peripheral, for notifying a user of a state of the apparatus and the remaining amount of a consumable (such as toners of the multifunction peripheral), a display method for displaying a character string in a part of a display area of the operation panel or for displaying a dialogue or the like in the entire operation area is known in the related art.

However, the display method of the related art can only display the character string which is fixedly set in the apparatus and timing of displaying is also fixed.

### SUMMARY OF THE INVENTION

It is a general object of at least one embodiment of the present invention to provide an apparatus, an information processing system, an information processing method, and a computer program product for being executed on a computer that substantially obviate one or more problems caused by the limitations and disadvantages of the related art.

An embodiment of the present invention provides an apparatus including a display unit in which data is displayed; a first reception unit configured to receive input of the data to be displayed in the display unit and a display condition for displaying the data; a determination unit configured to determine whether the display condition is satisfied in accordance with a change of status of the apparatus; and a display control unit configured to display the data in the display unit in response to an event in which the determination unit determines that the display condition is satisfied.

An embodiment of the present invention also provides an information processing method including a first reception step of receiving input of data to be displayed in a display unit and a display condition for displaying the data, the display unit being disposed in an apparatus; a determination step of determining whether the display condition is satisfied in accordance with a change of status of the apparatus; and a display controlling step of displaying the data in the display unit in response to an event in which it is determined that the display condition is satisfied in the determination step.

An embodiment of the present invention also provides a computer program product for being executed on a computer including a first reception step of receiving input of data to be displayed in a display unit and a display condition for displaying the data, the display unit being disposed in an apparatus; a determination step of determining whether the display condition is satisfied in accordance with a change of status of the apparatus; and a display controlling step of displaying the data in the display unit in response to an event in which it is determined that the display condition is satisfied in the determination step.

### BRIEF DESCRIPTION OF THE DRAWINGS

FIG. 1 is a block diagram illustrating an example of a hardware configuration of an image forming apparatus according to a first embodiment;

FIG. 2 is a block diagram illustrating an example of a functional configuration of the image forming apparatus according to the first embodiment;

FIG. 3 is a sequence chart illustrating a first example of a processing procedure of a displaying process of a message according to the first embodiment;

FIG. 4 is a table illustrating an example of display setting data according to the first embodiment;

FIG. 5 is a table illustrating examples of notification object information according to the first embodiment;

FIG. 6 is a sequence chart illustrating a second example of the processing procedure of the displaying process of the message according to the first embodiment;

FIG. 7 is a drawing illustrating examples of the messages;

FIG. 8 is a sequence chart illustrating an example of a compilation process of the display setting data according to the first embodiment;

FIG. 9 is a sequence chart illustrating an example of the processing procedure of the displaying process of the message according to a second embodiment;

FIG. 10 is a table illustrating an example of the display setting data according to the second embodiment;

FIG. 11 is a table illustrating examples of the notification object information according to the second embodiment;

FIG. 12 is a block diagram illustrating an example of a system configuration according to a third embodiment;

FIG. 13 is a block diagram illustrating an example of a hardware configuration of a user terminal according to the third embodiment;

FIG. 14 is a block diagram illustrating an example of functional configurations of the image forming apparatus and the user terminal; and

FIG. 15 is a sequence chart illustrating an example of a compilation process of the display setting data according to the third embodiment.

### DESCRIPTION OF THE PREFERRED EMBODIMENTS

In the following, embodiments of the present invention will be described with reference to the accompanying drawings.

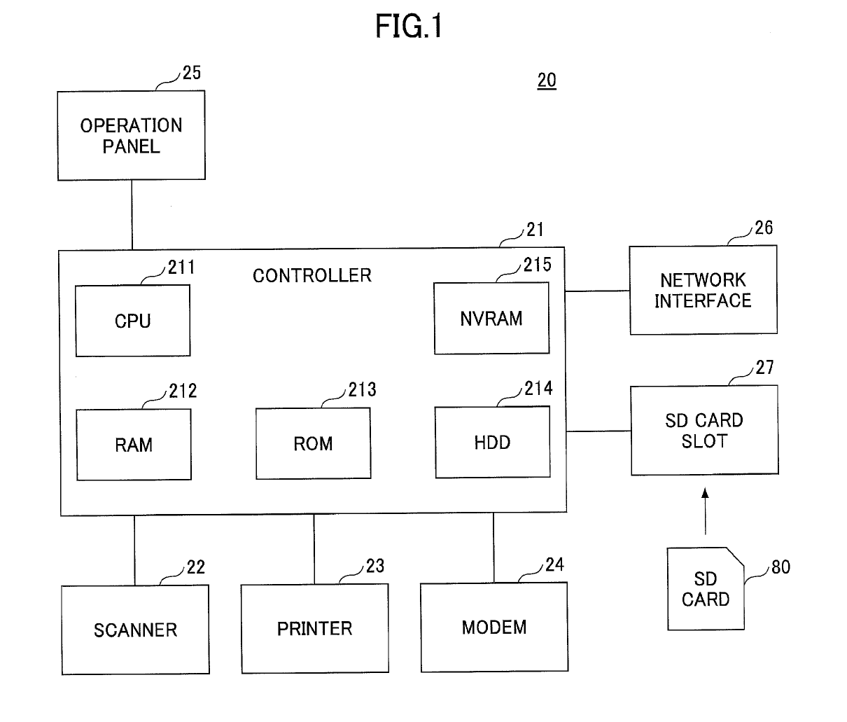

FIG. 1 is a block diagram illustrating an example of a hardware configuration of an image forming apparatus 20 according to a first embodiment. In FIG. 1, the image forming apparatus 20 includes hardware elements such as a controller 21, a scanner 22, a printer 23, a modem 24, an operation panel 25, a network interface 26, and an SD card slot 27.

The controller 21 includes a CPU (Central Processing Unit) 211, a RAM (Random Access Memory) 212, a ROM (Read Only Memory) 213, a HDD (Hard Disk Drive) 214 and a NVRAM (Non-Volatile Random Access Memory) 215. Various programs and data used by the programs are stored in the ROM 213. The RAM 212 is used, for example, as a storage space for loading the programs and a work space at which the loaded programs are processed. The CPU 211 implements various functions of the image forming apparatus 20 by processing the programs loaded on the RAM 212. The HDD 214 stores various programs and data used by the programs. The NVRAM 215 stores various kinds of setting information.

The scanner 22 is a hardware component (image reading unit) for reading image data from a document. The printer 23 is a hardware component (printing unit) for printing print data on a printing paper (sheet). The modem 24 is a hardware component for connecting the image forming apparatus 20 to a telephone line, and is used for sending and receiving image data through facsimile communications. The operation panel 25 is a hardware component includes an input unit, a display unit and the like. The input unit may include buttons for receiving input from a user. The display unit may include a liquid crystal panel. The liquid crystal panel may include a touch panel function. In this case, the liquid crystal panel also serves as the input unit. The network interface 26 is a hardware component for connecting the image forming apparatus 20 to a network (wired or wireless) such as a LAN. The SD card slot 27 is used for reading programs stored in an SD card 80. According to the image forming apparatus 20, in addition to the programs stored in the ROM 213, the programs stored in the SD card 80 can be loaded into the RAM 212 and executed. It should be noted that any other recording medium (for example, a CD-ROM or a Universal Serial Bus (USB) memory) may be used instead of the SD card 80. That is, a type of a recording medium that can be mounted on the image forming apparatus 20 is not limited to the SD card 80. In this case, the SD card slot 27 may be replaced with a hardware component corresponding to the type of the recording medium.

It should be noted that the operation panel may be an apparatus including a CPU and an operating system (OS) independent from the image forming apparatus 20 such as a dedicated or typical smartphone and a tablet terminal. For example, the operating system may be a system widely used in the smartphone or the tablet terminal such as Android (registered trademark). In this way, similar to the smartphone, the tablet terminal or the like, an expressive screen can be displayed and operational feeling can be provided. It should be noted that the operation panel 25 may be realized by another apparatus.

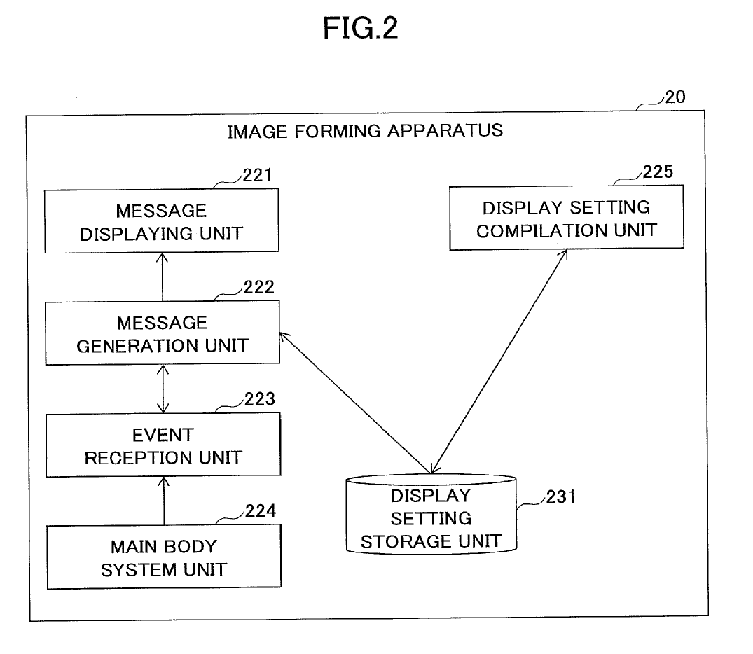

FIG. 2 is a block diagram illustrating an example of a functional configuration of the image forming apparatus 20 according to the first embodiment. In FIG. 2, the image forming apparatus 20 includes a message displaying unit 221, a message generation unit 222, an event reception unit 223, a main body system unit 224, a display setting compilation unit 225 and the like. These units may be implemented by processes which are executed by the CPU 211 or the operation panel 25 based on at least one program installed in the image forming apparatus 20. Further, the image forming apparatus 20 uses (includes) a display setting storage unit 231. The display setting storage unit 231 may be implemented by using, for example, a memory included in the HDD 214 or the operation panel 25, or a storage device which is able to be connected to the image forming apparatus 20 via the network.

The display setting storage unit 231 stores data (referred to as “display setting data” hereinafter) which includes setting information with regard to displaying of a message for notifying the user of some information. The display setting data includes, for each message, a combination of a display condition, a delete condition, a display content and the like. The display condition is information which indicates a condition for displaying the message. The delete condition is information which indicates a condition for deleting the message (hiding the message). The display content is data displayed as the message. The data displayed as the message may be a character string or image data. The image data may be a still image or a video image. It should be noted that the display setting data may be stored in a file.

The main body system unit 224 is a part which includes the hardware components shown in FIG. 1, an operating system (OS), a software platform and the like. Further, in a case in which the message displaying unit 221, the message generation unit 222, and the event reception unit 223 are implemented in the operation panel 25, the main body system unit 224 may be the controller 21 or a software group on the controller 21.

In the first embodiment, the main body system unit 224 functions as a source of occurrence of an event. The event is, for example, a phenomenon which indicates a change of status of the image forming apparatus 20. Arrival of a predetermined time, activation (starting) of the image forming apparatus 20, changing to an energy saving state, returning from the energy saving state, starting a job, finishing the job, changing the remaining amount of a consumable (for example, changing the remaining amount of toners or papers to an amount equal to or less than a predetermined amount such as running out of toners (toner near end) and running out of papers) or the like may be an example of the event. That is, the change of the status of the image forming apparatus 20 includes at least one of these. The event reception unit 223 determines whether the display condition or the hiding condition is satisfied in accordance with a change of the status of the image forming apparatus 20.

The event reception unit 223 detects the event which occurs in the main body system unit 224.

The message generation unit 222 reads the display setting data from the display setting storage unit 231 in order to set, in the event reception unit 223, the display condition, the delete condition and the like included in the display setting data. When the event reception unit 223 determines that some display condition is satisfied, the message generation unit 222 requests the message displaying unit 221 to display the display content which correspond to the satisfied display condition. Further, when the event reception unit 223 determines that some delete condition is satisfied, the message generation unit 222 requests the message displaying unit 221 to delete the display content which correspond to the satisfied delete condition.

The event reception unit 223 detects the event which occurs in the main body system unit 224. When the display condition or the delete condition, which has been set, is satisfied by the occurrence of the detected event, the event reception unit 223 notifies the message generation unit 222 that the display condition or the delete condition is satisfied.

The message displaying unit 221 displays, in the operation panel 25, the display content requested to be displayed from the message generation unit 222. Further, the message displaying unit 221 deletes (hides), from the operation panel 25, the display content requested to be deleted (hide) from the message generation unit 222.

The display setting compilation unit 225 generates or compiles the display setting data in accordance with an operation by the user of the image forming apparatus 20. In other words, the display setting compilation unit 225 receives the input of the display setting data.

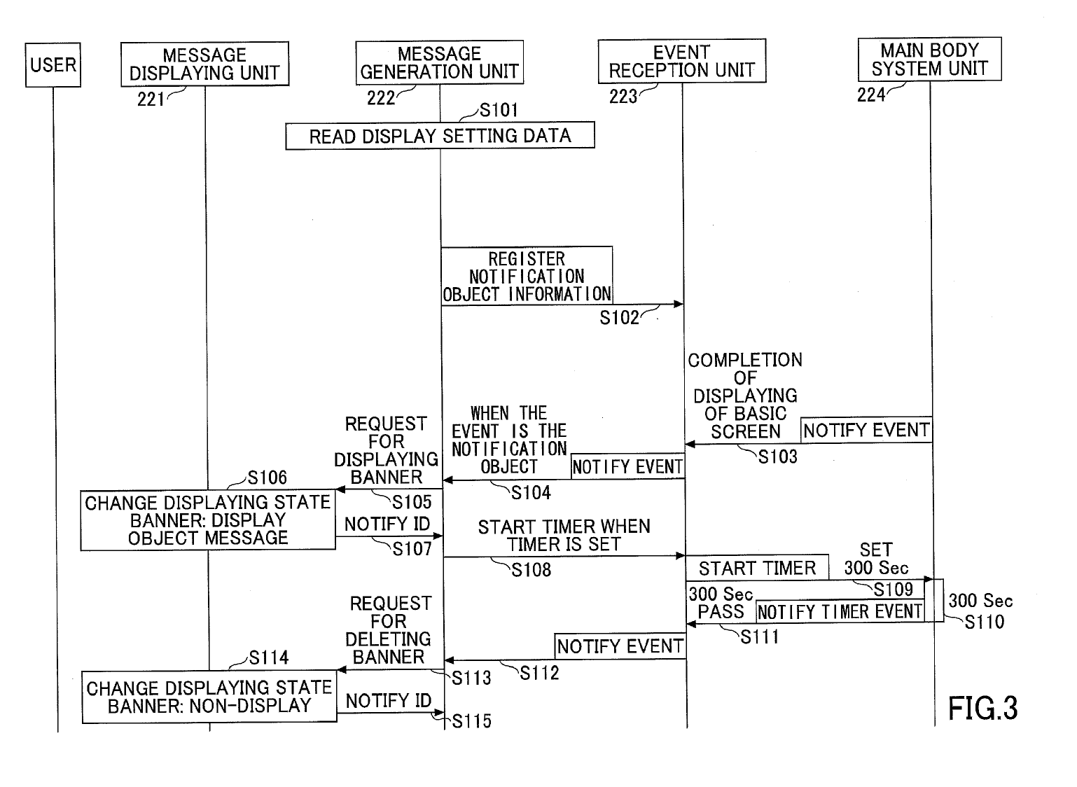

In the following, a processing procedure executed by the image forming apparatus 20 will be described. FIG. 3 is a sequence chart illustrating a first example of the processing procedure of a displaying process of the message (process for displaying the message) according to the first embodiment.

For example, when an activating (starting) process of the image forming apparatus 20 is completed, in step S101, the message generation unit 222 reads the display setting data from the display setting storage unit 231 when activating.

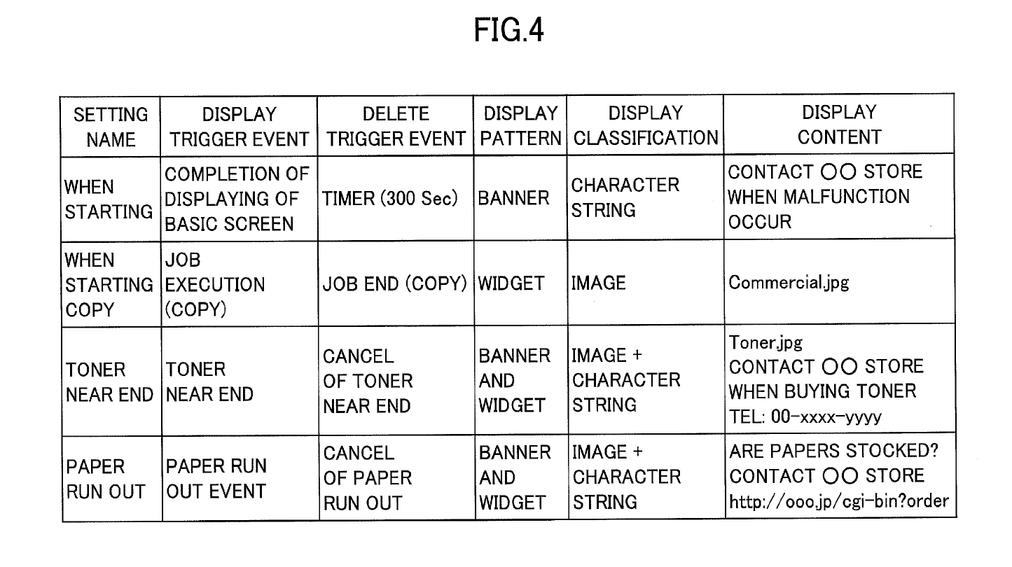

FIG. 4 is a table illustrating an example of the display setting data according to the first embodiment. As shown FIG. 4, the display setting data includes, for each of the messages, a setting name, a display trigger event, a delete trigger event, a display pattern, a display classification, a display content and the like. It should be noted that in the following, information of each row shown in FIG. 4 is referred to as the “display setting”.

The setting name is an identification name given to each of the display settings. The display trigger event is an example of the information described above as the display condition. That is, the display trigger event is information which indicates the event which is a trigger for displaying the message. The delete trigger event is an example of the information described above as the delete condition. That is, the delete trigger event is information which indicates the event which is a trigger for deleting (hiding) the message.

The display pattern is information which indicates a mode for displaying the message. “BANNER”, “WIDGET”, “BANNER AND WIDGET” or the like may be an example of a value of the display pattern. “BANNER” indicates displaying in a banner format. “WIDGET” indicates displaying in a widget format. “BANNER AND WIDGET” indicates displaying in a format which uses both the banner and the widget.

The display classification is information which indicates a classification of the display content. “CHARACTER STRING”, “IMAGE”, “IMAGE AND CHARACTER STRING” or the like may be an example of a value of the display classification. “CHARACTER STRING” indicates that the display content is a character string. “IMAGE” indicates that the display content is an image. “IMAGE AND CHARACTER STRING” indicates that the display content is a combination of the image and the character string.

The display content is a content to be displayed (information of a display object). The display content of the display setting whose display classification is the character string is a specific character string of the display object. The display content of the display setting whose display classification is the image is a file name of a file which stores the image of the display object. The display content of the display setting whose display classification is the image and the character string is the file name of the file which stores the image of the display object and the specific character string of the display object. It should be noted that the upper limit value of the number of characters may be set for the character string. Further, the upper limit value of a size of the image (height and width) may be set for the image. In these cases, the display content is set within the upper limit values.

It should be noted that in the examples shown in FIG. 4, the character string is displayed in the banner format and the image is displayed in the widget format.

Subsequently, in step S102, the message generation unit 222 registers, on the event reception unit 223, data which includes the setting name, the display trigger event, and the delete trigger event (referred to as “notification object information” herein after), for each of the display settings included in the display setting data.

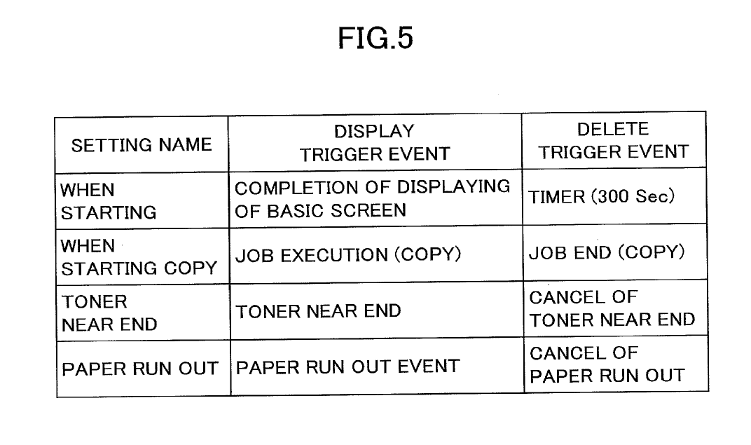

FIG. 5 is a table illustrating examples of the notification object information according to the first embodiment. As shown in FIG. 5, the setting name, the display trigger event, and the delete trigger event are extracted from each of the display settings shown in FIG. 4.

The event reception unit 223 waits for notification of the event from the main body system unit 224 after the notification object information shown in FIG. 5 is set.

For example, when displaying a basic screen (a home screen or an initial screen), which is displayed in the operation panel 25 at first after the image forming apparatus 20 is activated, is completed, the main body system unit 224 notifies the event reception unit 223 of the event “COMPLETION OF DISPLAYING OF BASIC SCREEN” in step S103. The event reception unit 223 determines whether the notified event is a notification object to the message generation unit 222 based on the notification object information. That is, when the notified event is the display trigger event or the delete trigger event of any one of the display settings, the event reception unit 223 determines the notified event as the notification object. The event “COMPLETION OF DISPLAYING OF BASIC SCREEN” corresponds to the display trigger event of the display setting whose setting name is “WHEN STARTING” (referred to as “first object setting” hereinafter) shown in FIG. 5. Accordingly, the event reception unit 223 notifies the message generation unit 222 of the event “COMPLETION OF DISPLAYING OF BASIC SCREEN” in step S104.

Subsequently, the message generation unit 222 specifies the display setting which corresponds to the notified event among the display settings included in the display setting data. In step S105, the message generation unit 222 requests the message displaying unit 221 to display the message which corresponds to the specified display setting. As shown in FIG. 4, the display pattern of the first object setting is “BANNER” and the display classification of the first object setting is “CHARACTER STRING”. Thus, the message generation unit 222 requests the message displaying unit 221 to display the banner of the character string being designated as the display content of the first object setting.

In response to the request from the message generation unit 222, the message displaying unit 221 changes a display state of a screen being displayed in the operation panel 25 in step S106. In this case, the character string of “CONTACT oo STORE WHEN MALFUNCTION OCCUR” is displayed as the banner.

Subsequently, the message displaying unit 221 generates display ID which is identification information corresponding to the banner being displayed currently, and returns the generated display ID to the message generation unit 222 in step S107. The message generation unit 222 stores the display ID in association with the first object setting.

As shown in FIG. 4, the delete trigger event of the first object setting is a timer event which occurs when a predetermined time period set as a timer passes. That is, the message of the first object setting is set such that the message is deleted when the predetermined time period (300 seconds) passes after starting displaying the message. Thus, the message generation unit 222 requests the event reception unit 223 to start the timer of 300 seconds (start counting 300 seconds) in step S108. The event reception unit 223 sets the timer of 300 seconds in the main body system unit 224 in step S109. It should be noted that at this time, the event reception unit 223 also stores the timer event, which occurs when the predetermined time period set as the timer passes, as the notification object to the message generation unit 222.

The main body system unit 224, in which the timer has been set, measures 300 seconds in step S110. When 300 seconds passes, the main body system unit 224 notifies the event reception unit 223 of the timer event in step S111. Because the timer event is stored as the notification object, in step S112, the event reception unit 223 notifies the message generation unit 222 of the timer event notified from the main body system unit 224.

Subsequently, the message generation unit 222 searches the display setting in which the timer event is set as the display trigger event or the delete trigger event from the display settings. In this case, the first object setting corresponds to the display setting. Thus, the message generation unit 222 requests the message displaying unit 221 to delete (hide) the message in step S113 while designating the display ID associated with the first object setting.

In response to the request, the message displaying unit 221 deletes the message in step S114 which corresponds to the display ID designated in the request. In this case, the message displayed in the banner in step S106 is deleted. Subsequently, in step S115, the message displaying unit 221 notifies the message generation unit 222 of the display ID which corresponds to the message deleted successfully. The message generation unit 222 cancels associating the display ID and the first object setting.

According to the processing procedure shown in FIG. 3, a predetermined message can notify the user in response to activating (starting) the image forming apparatus 20, automatically.

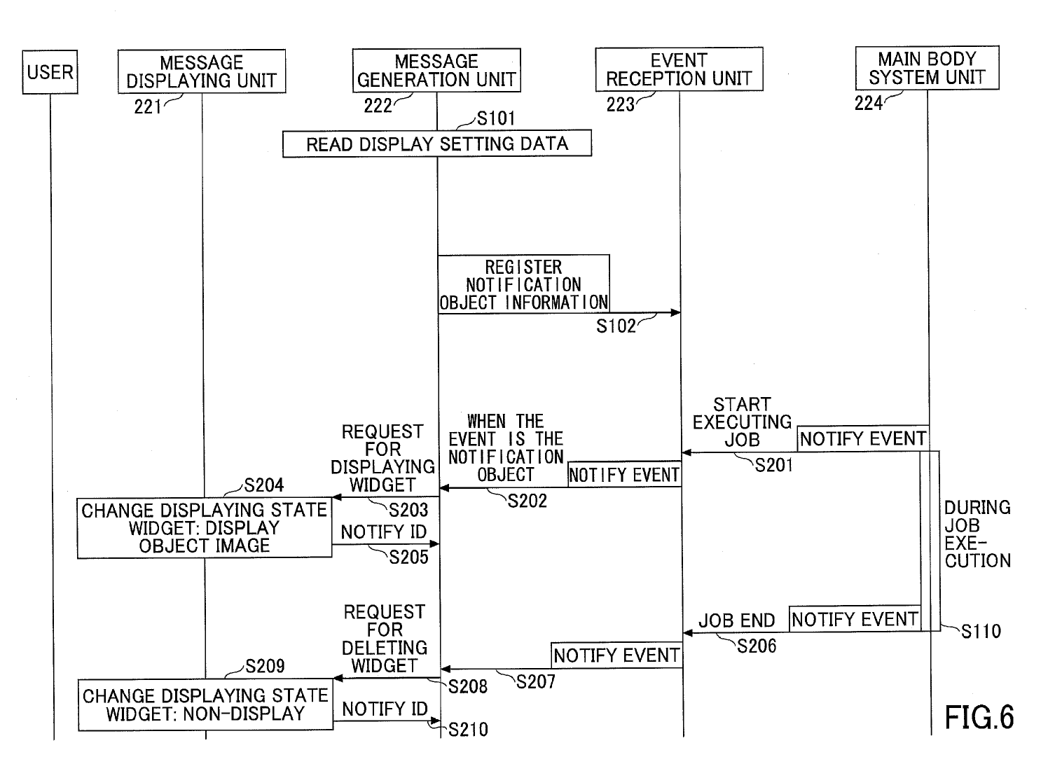

Subsequently, an example in which a widget is displayed during execution of a job will be described. FIG. 6 is a sequence chart illustrating a second example of the processing procedure of the displaying process of the message according to the first embodiment. In FIG. 6, step numbers which corresponds to the step numbers in FIG. 3 are referred to by the same step numbers, and their descriptions may be omitted as appropriate.

For example, when a copy job is started, the main body system unit 224 notifies the event reception unit 223 of an event of “JOB EXECUTION (COPY)” in step 201. The event reception unit 223 determines whether the notified event is the notification object to the message generation unit 222 based on the notification object information (shown in FIG. 5). As shown in FIG. 5, the event of “JOB EXECUTION (COPY)” corresponds to the display trigger event of the display setting whose setting name is “WHEN STARTING COPY” (referred to as the “second object setting” hereinafter). Thus, the event reception unit 223 notifies the message generation unit 222 of the event of “JOB EXECUTION (COPY)” in step S202.

Subsequently, the message generation unit 222 specifies the display setting which corresponds to the notified event among the display settings included in the display setting data. In step S203, the message generation unit 222 requests the message displaying unit 221 to display the message which corresponds to the specified display setting. As shown FIG. 4, the display pattern of the second object setting is “WIDGET” and the display classification of the second object setting is “IMAGE”. Thus, the message generation unit 222 requests the message displaying unit 221 to display the widget while designating the file name designated in the display content of the second object setting.

In response to the request from the message generation unit 222, the message displaying unit 221 changes a display state of a screen being displayed in the operation panel 25 in step S204. In this case, a widget in which an image stored in a file whose file name is Commercial. jpg is drawn is displayed. It should be noted that the image may be an image which indicates an advertisement of a shop of the image forming apparatus 20, for example.

Subsequently, the message displaying unit 221 generates display ID which corresponds to the displayed widget in order to return the generated display ID to the message generation unit 222 in step S205. The message generation unit 222 stores the display ID in association with the second object setting.

After that, when the copy job is finished, the main body system unit 224 notifies the event reception unit 223 of an event “JOB END (COPY)” in step S206. The event reception unit 223 determines whether the notified event is the notification object to the message generation unit 222 based on the notification object information (shown in FIG. 5). The event of “JOB END (COPY)” corresponds to the delete trigger event of the second object setting. Thus, the event reception unit 223 notifies the message generation unit 222 of the event of “JOB END (COPY)” in step S207.

Subsequently, the message generation unit 222 searches the display setting in which the event of “JOB END (COPY)” is set as the display trigger event or the delete trigger event from the display settings. In this case, the second object setting corresponds to the display setting. Thus, the message generation unit 222 requests the message displaying unit 221 to delete the message in step S208 while designating the display ID associated with the second object setting.

In response to the request, the message displaying unit 221 deletes the message in step S209 which corresponds to the display ID designated in the request. In this case, the widget displayed in step S204 is deleted. Subsequently, in step S210, the message displaying unit 221 notifies the message generation unit 222 of the display ID corresponding to the widget deleted successfully. The message generation unit 222 cancels the associating of the display ID and the second object setting.

According to the processing procedure shown in FIG. 6, the predetermined message can be automatically notified to the user only during the period in which the job is being executed.

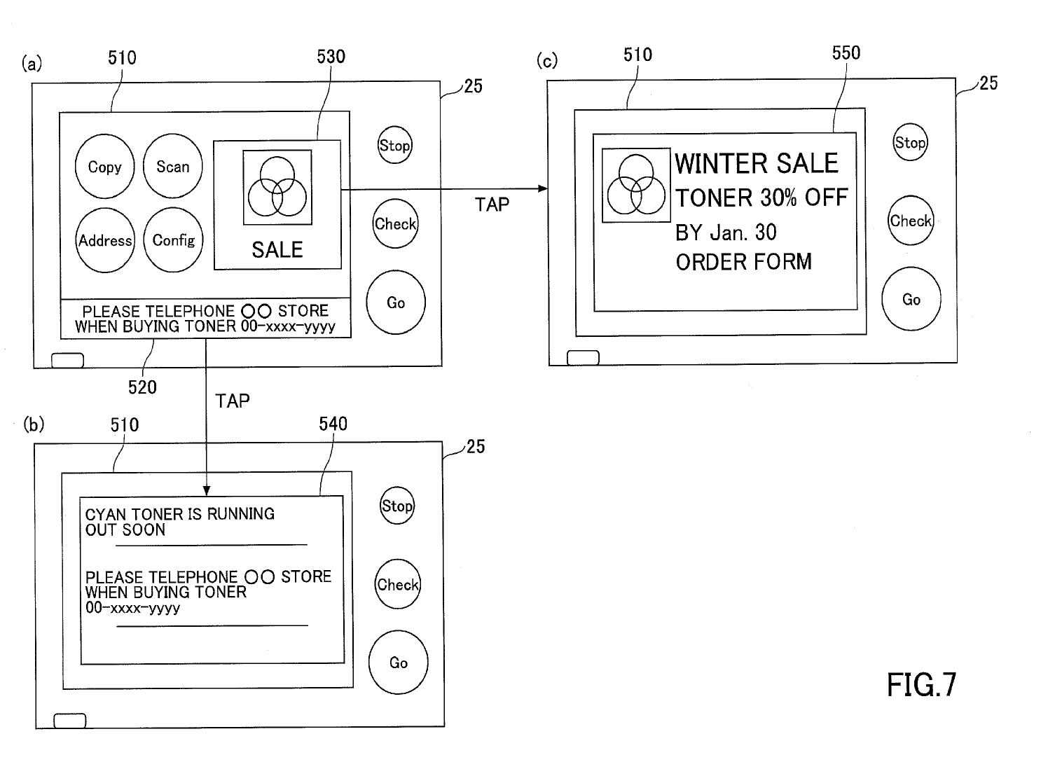

It should be noted that in the processing procedure in FIG. 3 or FIG. 6, the messages are displayed as shown in FIG. 7, for example. FIG. 7 is a drawing illustrating examples of the messages.

As shown In FIG. 7(a), in the basic screen 510 displayed in the operation panel 25, the banner 520 and the widget 530 are displayed.

The banner 520 is displayed in an edge part (for example, along a lower hem) of the basic screen 510. The banner 520 is displayed in an outside area of an area for normal operation such that the banner 520 does not obstruct other display elements in the basic screen 510. Further, changing displaying positions of the banner 520 (for example, displaying in a front face of the basic screen 510), deleting the banner 520 or the like may be performed easily according to a button operation, a flick operation or the like.

A long sentence to some extent can be displayed in the banner 520. Further, a plurality of character strings can be displayed in the banner 520 at the same time. Because a displaying area of the banner 520 has a limit, in a case in which the character strings are set, one of the character strings as the display object may be changed to another of the character strings at an interval of several seconds. Further, one of the character strings as the display object may be changed to another of the character strings according to a scroll operation.

As shown In FIG. 7(b), in a case in which the banner 520 is tapped (selected) by the user who browses the banner 520, the message displaying unit 221 may display, in the operation panel 25, a detail screen 540 which includes detailed information with regard to the message displayed in the banner 520. The detailed information may include, for example, information with regard to the event which has been the trigger for displaying the banner 520. Among the detailed information, information not being able to be displayed in the detail screen 540 (too much for displaying) may be displayed according to a flick operation or a scroll operation by the user.

On the other hand, the widget 530 may be, for example, a display element being able to be displayed graphically on the basic screen 510 side by side, similar to various icons. As shown In FIG. 7(a), both the image and the character string are displayed in the widget 530. For example, the widget 530 may be implemented by using a layout language such as hypertext markup language (HTML) and defining designation of the image and the character string for the display object, arrangement of the image and the character string, and sizes of the image and the character string.

Displaying positions of the widget 530 may be changed by the user. For example, in a case in which the widget 530 is displayed in a screen which including a plurality of faces in which the faces of the display object are changed according to a flick operation or the like, the displaying positions of the widget 530 may be changed within the faces.

As shown In FIG. 7(c), also in a case in which the widget 530 is tapped (selected) by the user, the message displaying unit 221 may display, in the operation panel 25, a detail screen 550 which includes detailed information with regard to the display content in the widget 530. In the detail screen 550, the detailed information, which includes the display content in the widget 530 as a part, is displayed. It should be noted that detailed information which does not include the display content of the widget 530 may be displayed in the detail screen 550.

A plurality of display contents can be set in the widget 530 at the same time. In this case, for notifying the user of pieces of information, one of the display contents may be changed to another of the display contents at an interval of several seconds. Further, one of the display contents as the display object may be changed to another of the display contents according to a side flick operation. Further, when a tab is displayed, the display contents may be changed according to an operation of the tab.

It should be noted that although the advertisements are displayed in the banner 520 and the widget 530 as the display objects, information displayed in the banner 520 and the widget 530 is not limited to the advertisement. For example, an announcement of a maintenance period of the image forming apparatus 20 may be displayed. Further, information for business irrelevant to the image forming apparatus 20 may be displayed. Other information may be displayed.

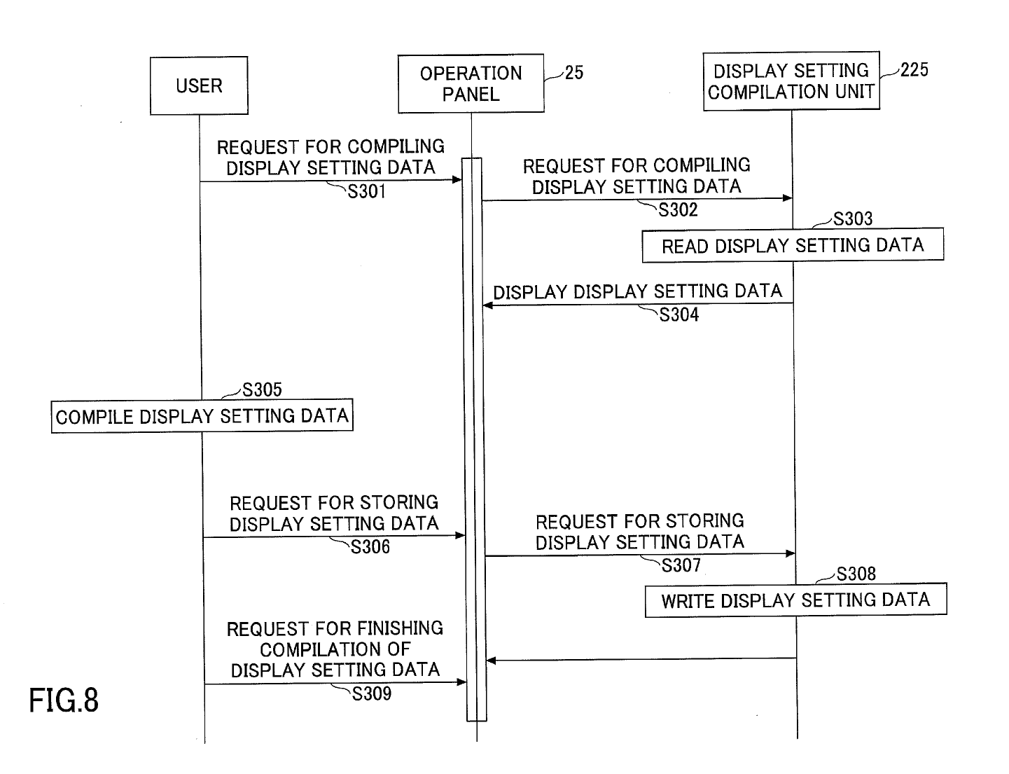

In the following, a compilation process (generation process) of the display setting data will be described. FIG. 8 is a sequence chart illustrating an example of a processing procedure of the compilation process of the display setting data (process for compiling the display setting data) according to the first embodiment. In FIG. 8, a user who has authority for compiling the display setting data is logging into the image forming apparatus 20.

When the user inputs a compilation request for compiling the display setting data via the operation panel 25 in step S301, the compilation request is notified to (input into) the display setting compilation unit 225 in step 302. In response to the compilation request, the display setting compilation unit 225 reads the display setting data from the display setting storage unit 231 in step S303. Subsequently, the display setting compilation unit 225 displays, in the operation panel 25, a compilation screen for compiling the display setting data in step S304. It should be noted that in a case in which the display setting data is newly generated (for example, the display setting data is not stored in the display setting storage unit 231), a value of each item of the display setting data in the compilation screen may be a blank or a preset value may be displayed in the compilation screen. Further, a configuration of the compilation screen is not limited to this. For example, the compilation screen may be a screen in which the display setting data is displayed in a tabular form as shown in FIG. 4 in order to be compiled.

The user compiles the display setting data via the compilation screen in step S305. For example, compiling (changing) the items of the existing display setting, deleting the existing display setting, or adding a new display setting may be performed. When a storage request for storing the display setting data is input in steps S306 and S307 after the compilation is completed, the display setting compilation unit 225 writes (stores), on the display setting storage unit 231, the display setting data as the result of the compilation in step S308.

After that, when the user inputs a finish request for finishing the compilation of the display setting data in step S309, the display setting compilation unit 225 finishes the compilation process of the display setting data.

As described above, according to the first embodiment, the image forming apparatus 20 can display the notification information such as the message based on the display setting data which is able to be compiled. The timing for displaying and deleting the notification information accords to the display setting data. That is, the timing for displaying and deleting each of the notification information items can be set by the user arbitrarily. For example, the first embodiment can display, in the image forming apparatus 20, unique information for unique shop(s) of the image forming apparatus 20 or for unique user(s) of the image forming apparatus 20 at unique timing(s). Thus, in the first embodiment, flexibility with regard to displaying the information in the image forming apparatus 20 can be improved.

Next, a second embodiment will be described. In the following, differences between the second embodiment and the first embodiment will be described. Thus, features of the second embodiment, which are not specifically described in the following, may be similar to the features of the first embodiment. In the description of the second embodiment, an example will be described in which a message being able to be displayed is changed in accordance with a user of the image forming apparatus 20.

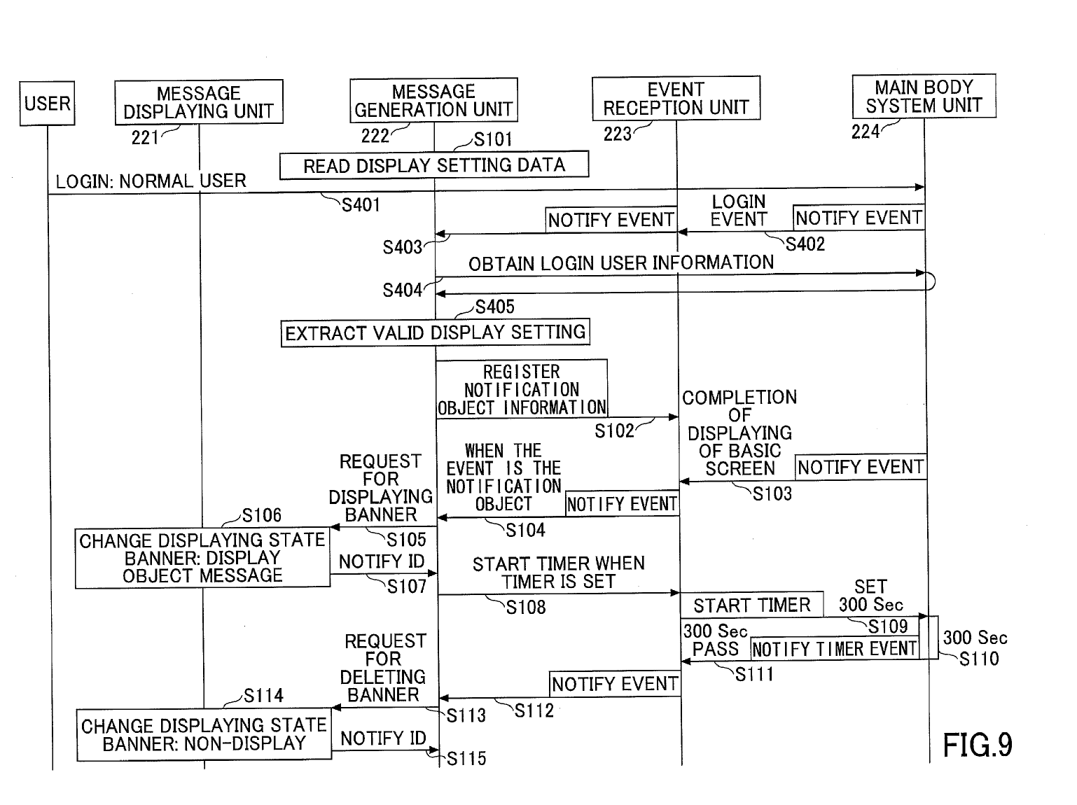

FIG. 9 is a sequence chart illustrating an example of the processing procedure of the displaying process of the message according to the second embodiment. In FIG. 9, step numbers which corresponds to the step numbers in FIG. 3 are referred to by the same step numbers, and their descriptions may be omitted as appropriate.

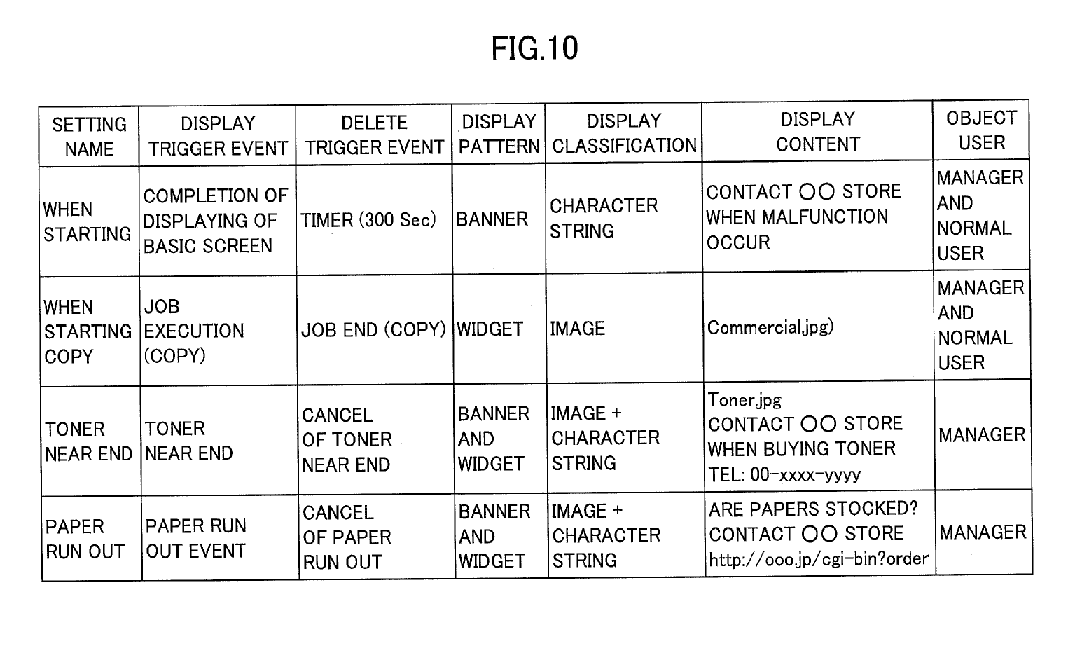

In the example shown in FIG. 9, in step S101, the display setting data as shown in FIG. 10 is read.

FIG. 10 is a table illustrating an example of the display setting data according to the second embodiment. In FIG. 10, the display setting data further includes an item of an object user. The object user is information which indicates a classification of the user (referred to as “user classification” in the following,) for whom each display setting is valid. The user classification is distinguished by operation authority with respect to the image forming apparatus 20. In the second embodiment, the user classification includes a manager user and a normal user. The manager user is a user who has manager authority (administrator authority). The user who has the manager authority may be, for example, a user who can use a management function of the image forming apparatus 20. The management function of the image forming apparatus 20 may be, for example, a function for changing various kinds of setting information with regard to the image forming apparatus 20. The normal user is a user who does not have the manager authority. For example, the normal user can use functions of the image forming apparatus 20 such as a copying function, a scanning function, and a printing function.

As shown in FIG. 10, the display settings of the first row and the second row are valid for both the manager user and the normal user. On the other hand, the display settings of the third row and the fourth row are valid only for the manager user.

When some user operates the operation panel in order to perform a login operation (such as inputting a user name and a password, or holding a predetermined card or an authentication device including an authentication function such as a smartphone and a mobile phone over it) into the image forming apparatus 20 in step S401. After the image forming apparatus 20 is activated and step S101 is executed, the main body system unit 224 performs authentication of the user. In a case in which the authentication is succeeded, the main body system unit 224 determines the user classification. In this case, the user is the normal user. It should be noted that the user classification (or the authority of the user) may be stored in, for example, a memory included in the HDD 214 or the operation panel 25, or an external device which is able to be connected to the image forming apparatus 20 via the network in association with each of the user names. Further, in the case in which the authentication has succeeded, the main body system unit 224 notifies the event reception unit 223 of a login event which indicates that the user logs into the image forming apparatus in step S402. The event reception unit 223 notifies the message generation unit 222 of the login event in step S403. The event reception unit 223 notifies the message generation unit 222 of all events because the notification object information is not registered in the event reception unit 223 at that time.

In response to the login event, the message generation unit 222 obtains login user information from the main body system unit 224 in step S404. The login user information is information with regard to the login user. The login user information may include, for example, the user name of the login user and the user classification.

Subsequently, the message generation unit 222 extracts the display setting(s) valid for the login user from the display setting data (shown in FIG. 10) in step S405. In this case, the display settings of the first row and the second row, shown in FIG. 10, are extracted because the login user is the normal user.

Subsequently, in step S102, the message generation unit 222 registers, on the event reception unit 223, the notification object information which corresponds to the extracted display settings.

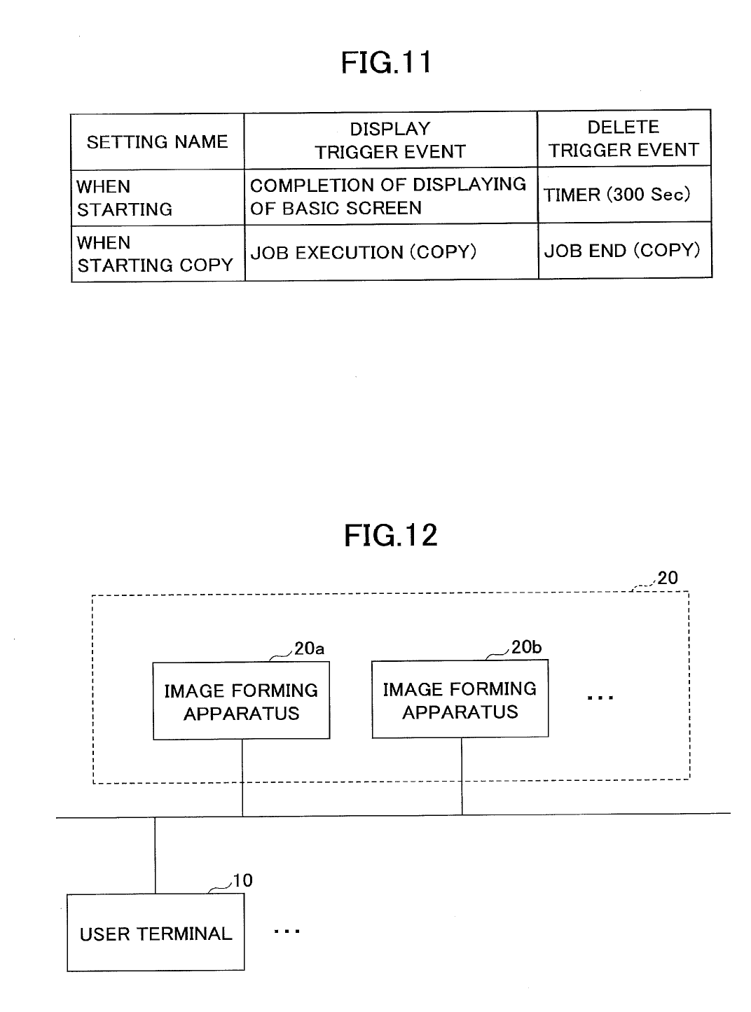

FIG. 11 is a diagram illustrating examples of the notification object information according to the second embodiment. In FIG. 11, the notification object information which corresponds to the display settings of the first row and the second row in FIG. 10 are displayed.

Thus, the event reception unit 223 does not report events which do not correspond to the display trigger events or the delete trigger events shown in FIG. 11. As a result, the display settings of the third row and the fourth row in FIG. 10 are invalidated.

Steps subsequent to step S103 in FIG. 9 are executed similarly to the process shown in FIG. 3. It should be noted that in a case in which the login user logs out, the event reception unit 223 may clear the notification object information being set.

As described above, in the second embodiment, the valid display setting can be changed in accordance with the user classification. It should be noted that, the valid display setting may be changed in accordance with a group distinguished by information other than the user name and the operation authority.

Next, a third embodiment will be described. In the following, differences between the third embodiment and the first and second embodiments will be described. Thus, features of the third embodiment, which are not specifically described, may be similar to the features of the first and second embodiments.

FIG. 12 is a block diagram illustrating an example of a system configuration according to the third embodiment. In FIG. 12, one or more image forming apparatuses 20, which include the image forming apparatus 20a and the image forming apparatus 20b, are connected to a user terminal 10 via the network (wired or wireless) such as the local area network (LAN) and the Internet.

The user terminal 10 is a terminal used for generating and compiling the display setting data. For example, a personal computer (PC), a mobile phone, a smartphone, and a tablet type terminal, a personal digital assistance (PDA) or the like may be used as the user terminal 10.

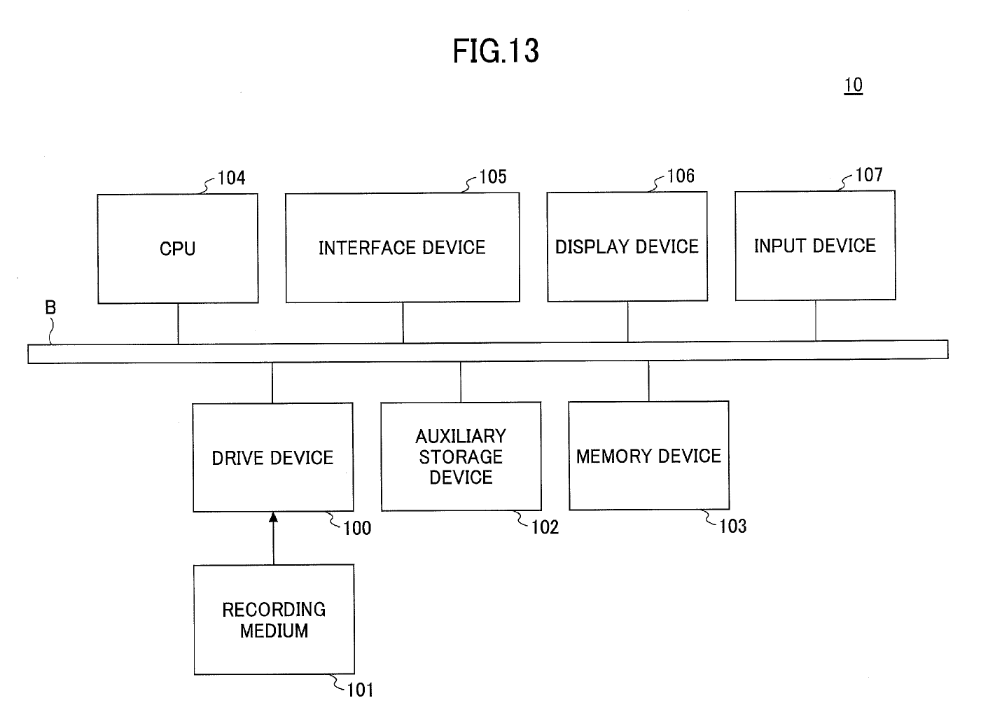

FIG. 13 is a block diagram illustrating an example of a hardware configuration of the user terminal 10 according to the third embodiment. In FIG. 13, the user terminal 10 and includes a drive device 100, an auxiliary storage device 102, a memory device 103, a CPU 104, an interface device 105, a display device 106 an input device 107, and the like which are connected to each other via a bus B.

A program for implementing a process executed in the user terminal 10 may be provided by a recording medium 101 such as a CD-ROM. When the recording medium 101 which stores the program is set in the drive device 100, the program is installed in the auxiliary storage device 102 from the recording medium 101 via the drive device 100. It should be noted that installing the program may be performed by downloading the program from another computer via the network. The auxiliary storage device 102 stores the installed program, necessary files, data and the like.

The memory device 103 reads out and stores the program from the auxiliary storage device 102 in response to an instruction for starting the program. The CPU 104 implements various functions of the user terminal 10 according to the program stored in the memory device 103. The interface device 105 may be used for connecting the user terminal 10 to the network. The display device 106 displays a graphical user interface (GUI) and the like according to the program. The input device 107 may include a keyboard, a mouse, or the like, and be used for inputting various operational instructions.

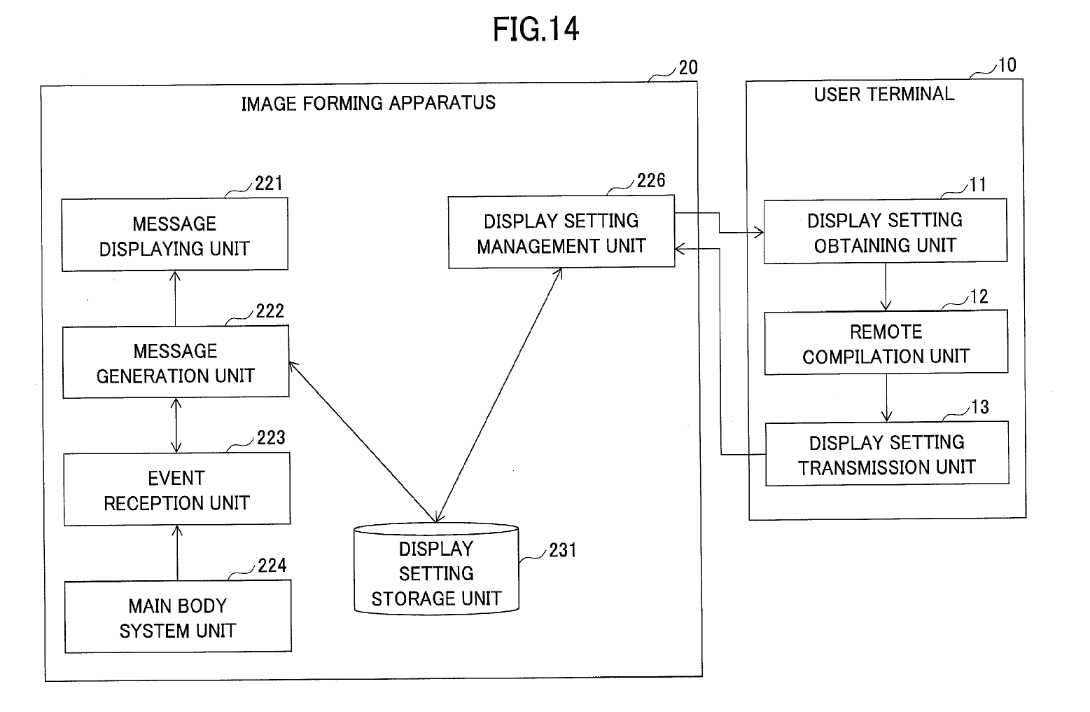

FIG. 14 is a block diagram illustrating an example of functional configurations of the image forming apparatus 20 and the user terminal 10. In FIG. 14, the image forming apparatus 20 includes a display setting management unit 226. In response to the request from the user, the display setting management unit 226 transmits, to the user terminal via the network, the display setting data stored in the display setting storage unit 231. Further, the display setting management unit 226 receives the display setting data transmitted from the user terminal 10, and writes the received display setting data on the display setting storage unit 231. It should be noted that the image forming apparatus 20 may include the display setting compilation unit 225 in the third embodiment.

On the other hand, the user terminal 10 includes a display setting obtaining unit 11, a remote compilation unit 12, a display setting transmission unit 13 and the like. These units may be implemented by processes which are executed by the CPU 104 based on at least one program installed in the user terminal 10.

The display setting obtaining unit 11 obtains the display setting data from the image forming apparatus 20. The remote compilation unit 12 generates or compiles the display setting data in accordance with the operation by the user of the user terminal 10. In other words, the remote compilation unit 12 receives the input of the display setting data. The display setting transmission unit 13 transmits, to the image forming apparatus 20, the display setting data generated or compiled by the remote compilation unit 12.

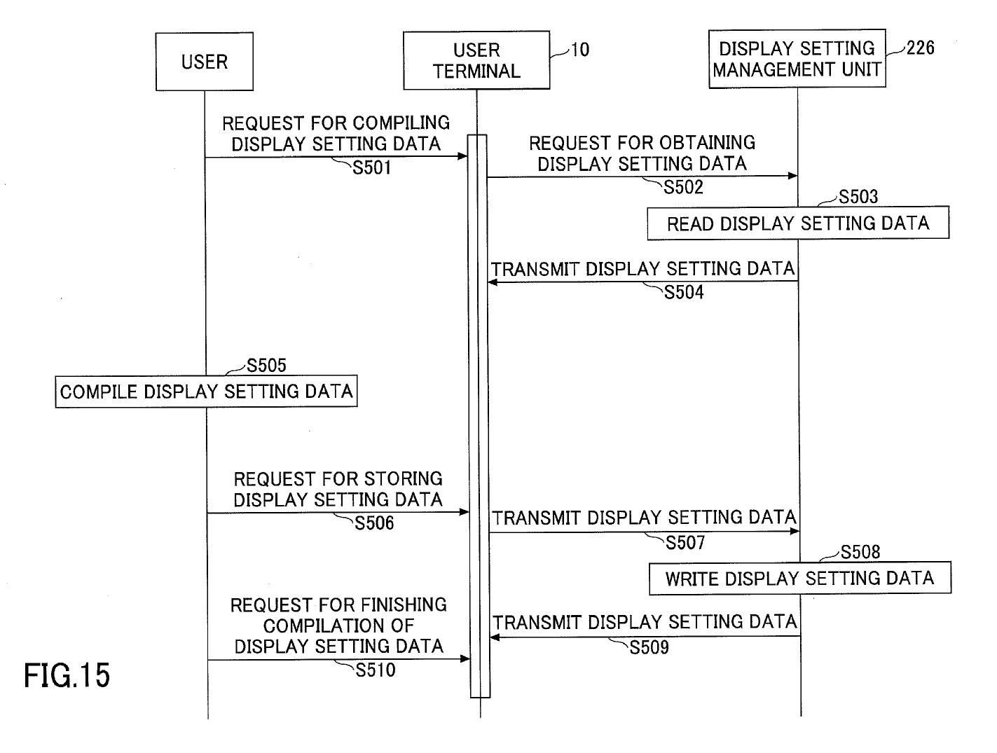

FIG. 15 is a sequence chart illustrating an example of the processing procedure of the compilation process of the displaying setting data according to the third embodiment. In FIG. 15, the user operates the user terminal 10.

When the user inputs a compilation request for compiling the display setting data with respect to the user terminal 10 in step S501, the display setting obtaining unit 11 transmits, to the image forming apparatus 20, an obtaining request for obtaining the display setting data in step S502. It should be noted that the image forming apparatus 20 of an obtaining destination for obtaining the display setting data may be selected by the user. Further, selecting the image forming apparatus 20 may be performed by inputting an IP address of the image forming apparatus 20 or by selecting from a list of the image forming apparatuses 20. When selecting the image forming apparatus 20 of the obtaining destination for obtaining the display setting data, the display setting obtaining unit 11 requests the image forming apparatus 20 selected by the user to transmit the obtaining request of the display setting data. Further, a remote login process into the image forming apparatus 20 may be performed before the process in step S502 is executed. In this case, steps subsequent to step S502 may be executed when the remote login process to the image forming apparatus 20 has succeeded.

In response to receiving the obtaining request of the display setting data, the display setting management unit 226 of the image forming apparatus 20 reads the display setting data from the display setting storage unit 231 in step S503. Subsequently, the display setting management unit 226 transmits (responds) the read display setting data to the user terminal 10 in step S504.

When the display setting obtaining unit 11 receives the display setting data, the remote compilation unit 12 displays, in the user terminal 10, the compilation screen of the display setting data. It should be noted that in a case in which the display setting data is newly generated (for example, the display setting data is not stored in the display setting storage unit 231 of the image forming apparatus 20 of the obtaining destination), values of items of the display setting data may be blanks or preset values in the compilation screen. Further, a configuration of the compilation screen is not limited to this. For example, the compilation screen may be a screen in which the display setting data is displayed in tabular form as shown in FIG. 4 such that the display setting data can be compiled.

The user compiles the display setting data via the compilation screen in step S505. The compilation content may be similar to the process described in FIG. 8. In response to the compilation operation by the user, the remote compilation unit 12 reflects the compilation operation in the display setting data.

After the compiling is completed, when a storage request for storing the display setting data is input in step S506, the display setting transmission unit 13 transmits the compiled display setting data to the image forming apparatus 20 in step S507. At this time, the image forming apparatus of a transmission destination, to which the display setting data is transmitted, may be selected by the user. That is, the transmission destination of the compiled display setting data may be different from the image forming apparatus 20 from which the display setting data before compiled has been obtained. Further, two or more image forming apparatuses 20 may be selected (designated) as the transmission destination of the display setting data.

In response to receiving the display setting data, the display setting management unit 226 of the image forming apparatus 20, which has been designated as the transmission destination of the display setting data, writes the received display setting data on the display setting storage unit 231 in step S508. Subsequently, in step S509, the display setting management unit 226 responds (transmits), to the user terminal 10, the response which indicates that writing the display setting data is completed. After that, when the user inputs a finish request of the compiling the display setting data in step S510, the remote compilation unit 12 finishes the compilation process of the display setting data. It should be noted that steps S502 to S504 may not be executed in a case in which the display setting data is newly generated. Further, a source of compiling is not limited to the display setting data obtained from the image forming apparatus 20. Display setting data which is stored in the user terminal 10 or the like may be an object for compiling.

As described above, according to the third embodiment, the user can generate and compile the display setting data using the user terminal 10. At this time, the same display setting data can be set in two or more image forming apparatuses 20 simultaneously. Thus, a workload of setting the display setting data can be reduced.

It should be noted that the above described embodiments may be applied to another apparatus other than the image forming apparatus 20. For example, the embodiments may be applied to an operation panel of a projector, a TV conference system, or a digital camera with regard to displaying information.

It should be noted that in the above described embodiments, one of the image forming apparatus 20 or the operation panel 25, or both the image forming apparatus 20 and the operation panel 25 are examples of an apparatus. The operation panel 25 is an example of a displaying unit. The user terminal 10 is an example of information processing apparatus. The display setting compilation unit 225 and the display setting management unit 226 are examples of a first reception unit. The event reception unit 223 is an example of a determination unit. The message displaying unit 221 is an example of display control unit. The remote compilation unit 12 is an example of a second reception unit. The display setting transmission unit 13 is an example of a transmission unit. The display setting storage unit 231 is an example of a storage unit. The display setting obtaining unit 11 is an example of an obtaining unit.

It should be noted that a person skilled in the field of information processing technology may employ the present invention using application specific integrated circuits (ASIC) or an apparatus in which circuit modules are connected.

Further, each of the functions (units) may be implemented by one or more circuits.

It should be noted that, in this specification, the circuit may include a processor programmed by software to execute the corresponding functions and hardware which is designed to execute the corresponding functions such as the ASIC and the circuit module.

Further, the present invention is not limited to these embodiments, but various variations and modifications may be made without departing from the scope of the present invention.

The present application is based on and claims the benefit of priority of Japanese Priority Application No. 2015-036829 filed on Feb. 26, 2015, with the Japanese Patent Office, the entire contents of which are hereby incorporated by reference.

What is claimed is:

1. An apparatus comprising:
a display unit in which data is displayed;
a first reception unit configured to receive input of the data to be displayed in the display unit and a display condition for displaying the data;
a determination unit configured to determine whether the display condition is satisfied in accordance with a change of status of the apparatus; and
a display control unit configured to display the data in the display unit in response to an event in which the determination unit determines that the display condition is satisfied.

2. The apparatus according to claim 1,
wherein the first reception unit is configured to receive input of a hiding condition for hiding the data being displayed in the display unit,
wherein the determination unit is configured to determine whether the hiding condition is satisfied in accordance with the change of the status of the apparatus, and
wherein the display control unit is configured to hide the data being displayed in the display unit in response to an event in which the determination unit determines that the hiding condition is satisfied.

3. The apparatus according to claim 1, wherein the display condition is input for each data displayed by the display unit.

4. The apparatus according to claim 1, wherein the change of the status of the apparatus includes at least one of displaying a predetermined screen in the display unit, starting a job executed by the apparatus, finishing a job executed by the apparatus, and changing the remaining amount of a consumable.

5. The apparatus according to claim 1, wherein the first reception unit is configured to receive the input of the data and the display condition via a network.

6. An information processing system comprising:
the apparatus according to claim 5; and
an information processing apparatus connected to the apparatus according to claim 5 via the network,
wherein the information processing apparatus includes a second reception unit configured to receive the input of the data and the display condition from a user and a transmission unit configured to transmit, to the apparatus according to claim 5, the data and the display condition received by the second reception unit.

7. The information processing system according to claim 6,
wherein the apparatus according to claim 5 includes a storage unit configured to store the data and the display condition received by the first reception unit,
wherein the information processing apparatus includes an obtaining unit configured to obtain, from the apparatus according to claim 5, the data and the display condition stored in the storage unit,
wherein the second reception unit is configured to change the data or the display condition in response to a request for changing the data or the display condition obtained by the obtaining unit, and
wherein the transmission unit is configured to transmit, to the apparatus according to claim 5, the data or the display condition changed by the second reception unit.

8. The information processing system according to claim 7, wherein the transmission unit is configured to transmit, to another apparatus, which is different from the apparatus according to claim 5 from which the data and the display condition are obtained by the obtaining unit, the data and the display condition changed by the second reception unit.

9. An information processing method comprising:
a first reception step of receiving input of data to be displayed in a display unit and a display condition for displaying the data, the display unit being disposed in an apparatus;
a determination step of determining whether the display condition is satisfied in accordance with a change of status of the apparatus; and
a display controlling step of displaying the data in the display unit in response to an event in which it is determined that the display condition is satisfied in the determination step.

10. The information processing method according to claim 9, further comprising:
a step of receiving input of a hiding condition for hiding the data being displayed in the display unit,
a second determination step of determining whether the hiding condition is satisfied in accordance with the change of the status of the apparatus, and
a step of hiding the data being displayed in the display unit in response to an event in which it is determined that the hiding condition is satisfied in the second determination step.

11. The information processing method according to claim 9, wherein the display condition is input for each data displayed by the display unit.

12. The information processing method according to claim 9, wherein the change of the status of the apparatus includes at least one of displaying a predetermined screen in the display unit, starting a job executed by the apparatus, finishing a job executed by the apparatus, and changing the remaining amount of a consumable.

13. The information processing method according to claim 9, wherein the input of the data and the display condition are received via a network in the first reception step.

14. The information processing method according to claim 13, further comprising:
a second reception step of receiving the input of the data and the display condition from a user; and
a transmission step of transmitting, to the apparatus connected to the network, the data and the display condition received in the second reception step.

15. The information processing method according to claim 14, further comprising:
a storing step of storing the data and the display condition received in the first reception step;
an obtaining step of obtaining, from the apparatus, the data and the display condition stored in the storing step;
wherein the data or the display condition obtained in the obtaining step is changed in response to a request for changing the data or the display condition in the second reception step, and
wherein the data or the display condition changed in the second reception step is transmitted to the apparatus in the transmission step.

16. The information processing method according to claim 15, wherein the data or the display condition changed in the second reception step is transmitted, to another apparatus, which is different from the apparatus from which the data or the display condition is obtained in the obtaining step.

17. A computer program product for being executed on a computer comprising:
a first reception step of receiving input of data to be displayed in a display unit and a display condition for displaying the data, the display unit being disposed in an apparatus;
a determination step of determining whether the display condition is satisfied in accordance with a change of status of the apparatus; and
a display controlling step of displaying the data in the display unit in response to an event in which it is determined that the display condition is satisfied in the determination step.

18. The computer program product according to claim 17, further comprising:
a second reception step of receiving the input of the data and the display condition from a user; and
a transmission step of transmitting, to the apparatus connected to a network, the data and the display condition received in the second reception step.
